(19) United States
(12) Patent Application Publication
(10) Pub. No.: US 2007/0192640 A1
(43) Pub. Date: Aug. 16, 2007

(54) Information processing device, information processing system, and shutdown method of operating system

(75) Inventor: Hideki Fukuchi, Ome-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/699,672

(22) Filed: Jan. 29, 2007

(30) Foreign Application Priority Data
Jan. 31, 2006 (JP) 2006-022943

(51) Int. Cl. G06F 1/00

(52) U.S. Cl. 713/300

(57) ABSTRACT

According to one embodiment, an information processing device includes a connection hole which is made in a peripheral wall and into which a hook portion of a lock unit is insertable, the lock unit including the hook portion which is rotatable between a locked position and an unlocked position, a detecting section which detects whether or not the hook portion of the lock unit is inserted into the connection hole, a judging section which judges whether or not the hook portion is inserted into the connection hole, in accordance with a detection result of the detecting section when execution of shutdown processing of an operating system is required, and a prohibiting section which prohibits the execution of the shutdown processing until the hook portion is inserted into the connection hole when it is judged that the hook portion is not inserted into the connection hole.

### CROSS-REFERENCE TO RELATED APPLICATIONS

This application is based upon and claims the benefit of priority from Japanese Patent Application No. 2006-022943, filed Jan. 31, 2006, the entire contents of which are incorporated herein by reference.

### BACKGROUND

1. Field

One embodiment of the invention relates to an information processing device to which, for example, a security wire can be attached, an information processing system and a shutdown method of an operating system.

2. Description of the Related Art

In recent years, portable information devices represented by portable computers have broadly spread. To improve the portability of such computers, miniaturization, slimming down and weight reduction have been promoted, and the computers can be put in bags or the like and can be readily carried.

In addition, the portable computer is generally used not only outdoors but also on a desk of an office in the same manner as a desktop computer. In this case, the portable computer can readily be carried, but there is a possibility of theft if the computer is allowed to stand on the desk. Therefore, the conventional portable computer is provided with an antitheft slot. The slot is used to disconnectably connect it to an antitheft unit, and the slot is opened at one place in a side surface or a rear surface of a housing of the portable computer (Jpn. Pat. Appln. KOKAI Publication No. 11-73241 (paragraph number [0013], FIG. 5)).

The antitheft unit for the portable computer includes a tough security cable made by bundling, for example, metal wires, and a lock cylinder fixed to one end of this security cable. The lock cylinder has a hook-like head portion detachably inserted into the slot of the housing, and this head portion is constituted to be revolved between a locked position and an unlocked position by a lock key.

Therefore, the portable computer can be fastened to an external fixed object such as the desk of the office via the security cable by fastening the security wire to the fixed object, and then inserting the head portion of the lock cylinder into the slot of the housing, followed by locking it. In consequence, the portable computer is inhibited from being moved and taken out, and theft of this portable computer can be prevented.

Even when a user uses the portable computer on the desk in the office, the user sometimes forgets to attach the above security wire to the computer. When the computer is driven, the user is using the computer or the user soon comes back after a short time, and hence there is little possibility that the computer is stolen.

However, when the computer is shut down, there is a possibility that the user has left the office, and the computer is allowed to stand for a long time. In such circumstances, the possibility that the computer is stolen increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing one example of a constitution including a notebook-size personal computer (an information processing device) as an information processing system according to one embodiment of the present invention, and a security wire as a lock unit;

FIG. 2 is an exemplary perspective view obtained by observing from the outside a security slot portion of a computer main body in a state in which any security wire is not attached;

FIG. 3 is an exemplary perspective view obtained by observing from the inside the security slot portion of the computer main body in a state in which any security wire is not attached;

FIG. 4 is an exemplary perspective view obtained by observing from the outside the security slot portion of the computer main body in a state in which the security wire is attached;

FIG. 5 is an exemplary perspective view obtained by observing from the inside the security slot portion of the computer main body in a state in which the security wire is attached;

FIG. 6 is an exemplary sectional view of the security slot portion of the computer main body in a state in which any security wire is not attached;

FIG. 7 is an exemplary sectional view of the security slot portion of the computer main body in a state in which the security wire is attached;

FIG. 8 is an exemplary block diagram showing one example of a system constitution of a computer according to one embodiment of the present invention;

FIG. 9 is an exemplary flowchart showing a procedure of processing to shut down a system; and

FIG. 10 is an exemplary diagram showing an example of a warning window to be displayed in a case where any security wire is not attached to the computer main body.

### DETAILED DESCRIPTION

Various embodiments according to the invention will be described hereinafter with reference to the accompanying drawings. In general, according to one embodiment of the invention, an information processing device comprises a body having a housing with a peripheral wall, a connection hole which is made in the peripheral wall of the housing and into which a hook portion of a lock unit is insertable, the lock unit including the hook portion which is rotatable between a locked position and an unlocked position, a detecting section which detects whether or not the hook portion of the lock unit is inserted into the connection hole, a judging section which judges whether or not the hook portion is inserted into the connection hole, in accordance with a detection result of the detecting section when execution of shutdown processing of an operating system is required, and a prohibiting section which prohibits the execution of the shutdown processing until the hook portion is inserted into the connection hole when it is judged that the hook portion is not inserted into the connection hole.

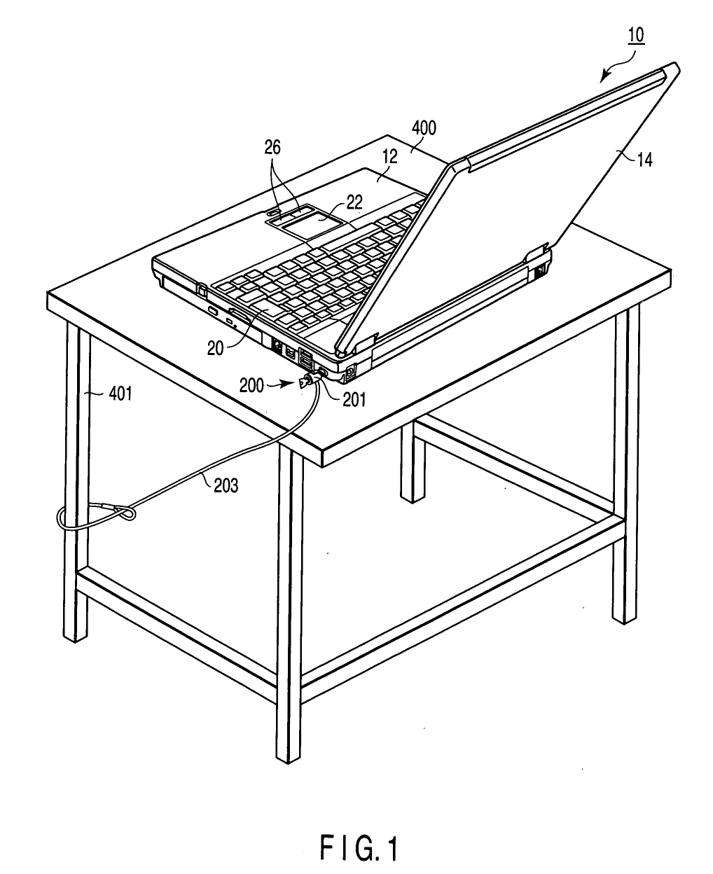

FIG. 1 is a diagram showing one example of a constitution including a notebook-size personal computer (an information processing device) as an information processing system according to a first embodiment of the present invention, and a security wire and a remote controller as lock units.

A personal computer 10 is constituted of a computer main body 12 and a display unit 14.

The display unit 14 as a display section is attached to hinges disposed on distal end portions of the computer main body 12 so that the unit is revolvable between an opened position where the upper surface of the computer main body 12 is exposed and a closed position where an upper surface of the computer main body 12 is covered.

The computer main body 12 has a thin box-like housing, and a keyboard 20 as an input section is disposed in the center of an upper surface of the housing. A palm rest is formed in the upper surface of a proximal housing portion of the computer main body 12. In a substantially central portion of the palm rest, and a touchpad 22 and touchpad control buttons 26 are arranged. On an upper surface of a distal housing portion of the computer main body 12, a power button is disposed to turn on/off a power source of the computer main body 12.

A hook disposed on a head portion 201 of a security wire 200 is inserted into a security slot (a connection hole) disposed in a peripheral edge portion of the housing constituting the computer main body 12, so that the security wire 200 is connected to the computer main body 12.

One end of a cable 203 of the security wire 200 is disconnectably connected to the head portion 201 of the security wire 200. The other end of the cable 203 is connected to a leg 401 of a desk 400 as an external fixed object which cannot easily be moved, whereby theft of the computer 10 is prevented.

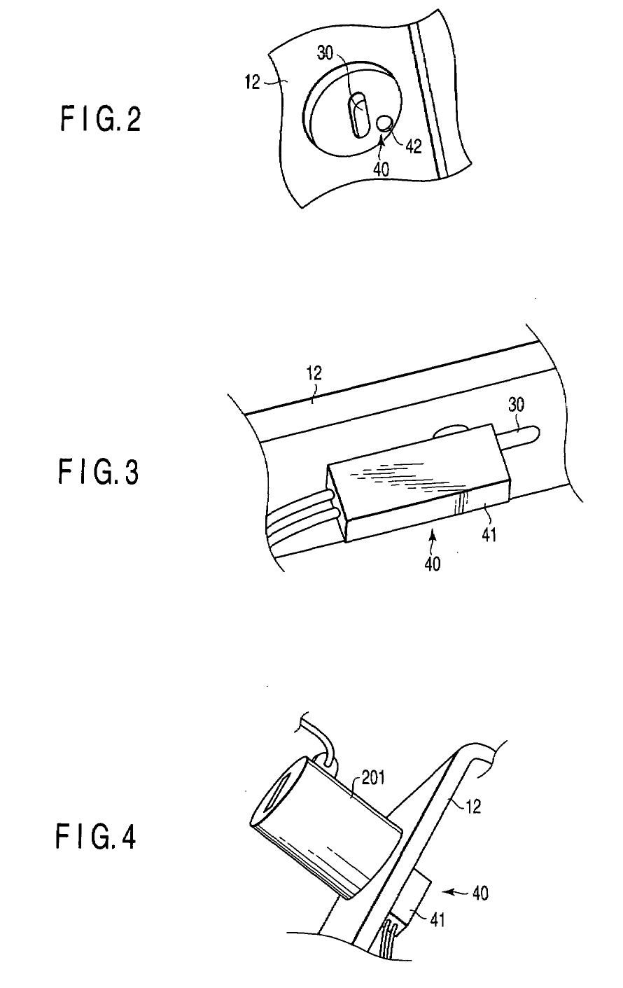

Constitutions of a security slot portion of the computer main body and the security wire will be described with reference to FIGS. 2 to 7.

FIG. 2 is a perspective view obtained by observing from the outside a security slot portion of a computer main body 12 in a state in which any security wire is not attached. FIG. 3 is a perspective view obtained by observing from the inside the security slot portion of the computer main body 12 in a state in which any security wire is not attached.

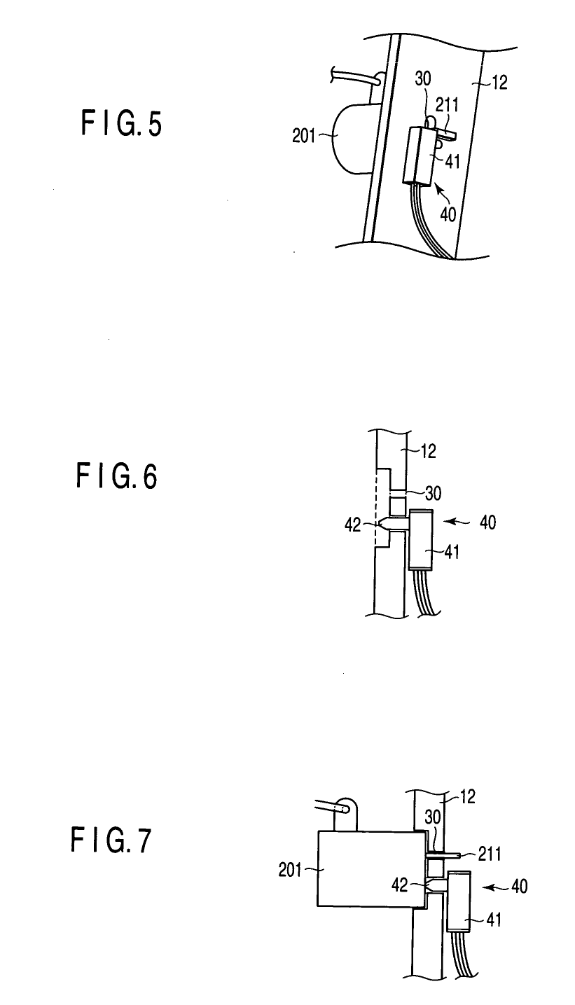

Moreover, FIG. 4 is a perspective view obtained by observing from the outside the security slot portion of the computer main body 12 in a state in which the security wire is attached. FIG. 5 is a perspective view obtained by observing from the inside the security slot portion of the computer main body 12 in a state in which the security wire is attached.

In addition, FIG. 6 is a sectional view of the security slot portion of the computer main body 12 in a state in which any security wire is not attached. FIG. 7 is a sectional view of the security slot portion of the computer main body 12 in a state in which the security wire is attached.

As shown in FIGS. 2, 3 and 6, a button 42 of a switch 40 is disposed around a security slot 30 on an outer side of the computer main body 12. A switch main body 41 of the switch 40 is disposed in the computer main body 12.

As shown in FIGS. 4, 5 and 7, when a hook 211 is inserted into the security slot 30 and the head portion 201 presses the button 42, the switch 40 is brought into, for example, an on-state. Then, the hook 211 is revolved from an unlocked position to a locked position. In consequence, the hook 211 is caught by an opening edge portion of the security slot 30 to achieve connection therebetween.

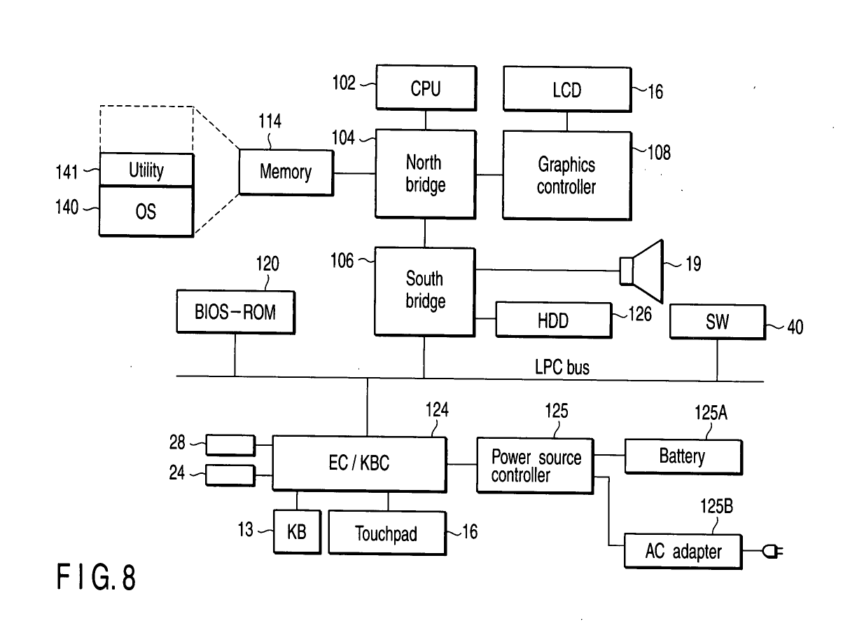

Next, one example of a system constitution including the computer, the security wire and the remote controller will be described with reference to FIG. 8.

As shown in FIG. 8, the present computer includes a CPU 102, a north bridge 104, a main memory 114, a graphics controller 108, a south bridge 106, a BIOS-ROM 120, a hard disk drive (HDD) 126, an embedded controller/keyboard controller IC (EC/KBC) 124, a power source controller 125 and the like.

The CPU 102 is a processor disposed to control an operation of the present computer, and executes various application programs such as an operating system (OS) 140 and a utility 141 loaded into the main memory 114 from the hard disk drive (HDD) 126. The utility 141 can detect that execution of shutdown processing of the operating system 140 has been required, and performs predetermined processing in a case where the execution of the shutdown processing is required. It is to be noted that the shutdown processing of the operating system includes processing to turn off a power source of the computer main body 12 and suspending.

Moreover, the CPU 102 loads, into the main memory 114, a system basic input output system (BIOS) stored in the BIOS-ROM 120, and then executes the system. The system BIOS is a program for hardware control.

The north bridge 104 is a bridge device which connects a local bus of the CPU 102 to the south bridge 106. A memory controller which accesses and controls the main memory 114 is also incorporated in the north bridge 104. The north bridge 104 also has a function of executing communication with the graphics controller 108 via an accelerated graphics port (AGP) bus or the like.

The south bridge 106 controls devices on a low pin count (LPC) bus. The south bridge 106 contains an integrated drive electronics (IDE) controller, a peripheral component interconnect (PCI) controller, a USB controller and an audio controller to control the hard disk drive (HDD) 126 and an optical disk drive (ODD). The audio controller permits emitting sound from a speaker 19.

The graphics controller 108 is a display controller which controls an LCD 16 for use as a display monitor of the present computer. This graphics controller 108 has a video memory (VRAM), and generates a video signal which forms a display image to be displayed on the LCD 16 from display data drawn in the video memory in accordance with an OS/application program. The video signal generated by the graphics controller 108 is output to a line.

The embedded controller/keyboard controller IC 124 functions as a controller which controls the touchpad 22 and the touchpad control buttons 26 as input means. The embedded controller/keyboard controller IC 124 is a one chip microcomputer which monitors and controls various devices (peripherals, sensors, a power source circuit, etc.) regardless of a system state of the computer system 10.

The power source controller 125 generates a system power source to be supplied to components of the present computer 10 by use of an external power source supplied via a battery 125A or an AC adapter 125B.

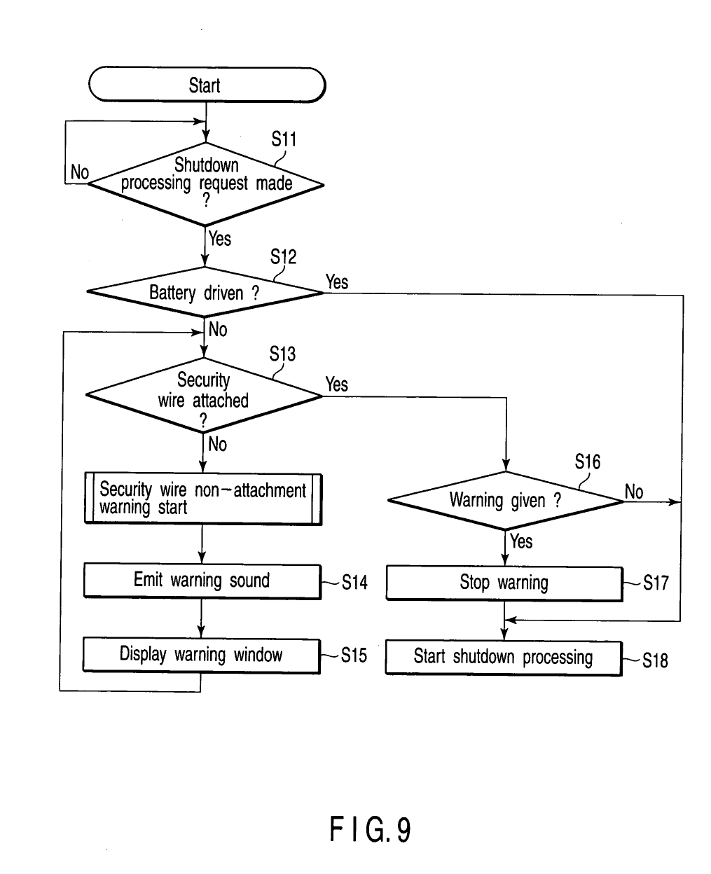

Next, a procedure of processing to shut down the system in a state in which the computer 10 is started will be described with reference to a flowchart of FIG. 9.

On receiving a request for the execution of the shutdown processing, the operating system 140 interrupts the utility 141 to notify the utility that the request for the execution of the shutdown processing has been made.

The utility 141 judges whether or not there has been an interrupt notice to perform the request for the execution of the shutdown processing (step S11). In a case where the request for the execution of the shutdown processing is not performed (No in step S11), the utility again judges whether or not there has been the interrupt notice to perform the request for the execution of the shutdown processing (step S11).

In a case where the request for the execution of the shutdown processing is performed (Yes in step S11), the utility 141 judges whether or not the computer 10 is driven by the battery 125A (step S12). If the computer is driven by the battery 125A, the computer 10 can judge that the security wire cannot be attached. The system BIOS manages whether or not the computer is driven by the battery 125A. When the utility 141 inquires of the system BIOS, it can be seen whether or not the computer is driven by the battery 125A.

When the computer is not driven by the battery 125A (No in step S12), the utility refers to a state of the switch main body 41 to judge whether or not the security wire 200 is attached to the computer main body 12 (step S13).

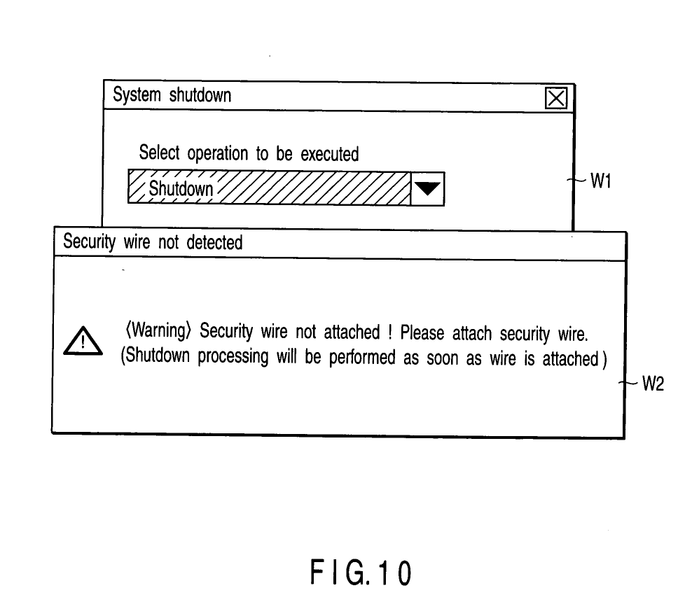

When the security wire 200 is not attached (No in step S13), the utility 141 prohibits the execution of the shutdown processing of the operating system 140, and starts security wire non-attachment warning. First, the utility 141 performs the security wire non-attachment warning to emit a warning sound as a predetermined sound from the speaker 19 (step S14). Moreover, as shown in FIG. 10, a warning window W2 including a warning message as a predetermined message is displayed on the LCD 16 so that the window is superimposed on a window W1 which allows a user to select processing to be executed (step S15). After the processing of step S15, the utility 141 refers to the state of the switch 40 to thereby judge whether or not the security wire 200 is attached (step S13).

In a case where it is judged in the processing of step S13 that the security wire 200 is attached (Yes in step S13), the utility 141 judges whether or not the warning is being performed (step S16). If the warning is being performed (Yes in step S16), the utility 141 stops the warning (step S17).

When it is judged in the processing of step S12 that the computer is driven by the battery (Yes in step S12), when it is judged in the processing of step S16 that the warning is not performed (No in step S16) or after the processing of step S17 is performed, the utility 141 permits the execution of the shutdown processing of the operating system 140, and the shutdown processing of the operating system 140 is started (step S18).

In the above processing, in a case where the computer is not driven by the battery (the computer is driven by an AC power source), if the security wire 200 is not attached to the computer main body 12, the shutdown processing is not started. As a result, it is possible to realize avoidance of a security risk that the security wire is forgotten to be attached, for example, at a time when the user leaves an office (when the user stops and leaves the computer), and it is possible to reduce a possibility that the computer 10 is stolen.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a body having a housing with a peripheral wall;
a connection hole which is made in the peripheral wall of the housing and into which a hook portion of a lock unit is insertable, the lock unit including the hook portion which is rotatable between a locked position and an unlocked position;
a detecting section which detects whether or not the hook portion of the lock unit is inserted into the connection hole;
a judging section which judges whether or not the hook portion is inserted into the connection hole, in accordance with a detection result of the detecting section when execution of shutdown processing of an operating system is required; and
a prohibiting section which prohibits the execution of the shutdown processing until the hook portion is inserted into the connection hole when it is judged that the hook portion is not inserted into the connection hole.

2. The information processing device according to claim 1, further comprising:
a speaker; and
a warning section which emits a predetermined sound from the speaker, when the judging section judges that the hook portion is not inserted into the connection hole.

3. The information processing device according to claim 1, further comprising:
a display panel; and
a message display section which displays a predetermined message in the display panel when the judging section judges that the hook portion is not inserted into the connection hole.

4. The information processing device according to claim 1, wherein the body is drivable by a battery;
the device further comprising:
a judging section which judges whether or not the body is driven by the battery when the execution of the shutdown processing of the operating system is required; and
a permitting section which permits the execution of the shutdown processing of the operating system when it is judged that the body is driven by the battery.

5. An information processing system comprising:
a lock unit having a hook portion which is rotatable between a locked position and an unlocked position; and
an information processing device including a connection hole which is made in a peripheral wall of a housing and into which the hook portion is insertable; a detecting section which detects whether or not the hook portion of the lock unit is inserted into the connection hole; a judging section which judges whether or not the hook portion is inserted into the connection hole, in accordance with a detection result of the detecting section when execution of shutdown processing of an operating system is required; and a prohibiting section which prohibits the execution of the shutdown processing until the hook portion is inserted into the connection hole when it is judged that the hook portion is not inserted into the connection hole.

6. The information processing system according to claim 5, wherein the information processing device further includes a speaker; and a warning section which emits a predetermined sound from the speaker when the judging section judges that the hook portion is not inserted into the connection hole.

7. The information processing system according to claim 5, wherein the information processing device further includes a display panel; and a message display section which displays a predetermined message in the display panel when the judging section judges that the hook portion is not inserted into the connection hole.

8. The information processing system according to claim 5, wherein the information processing device is drivable by a battery; and
the information processing device further includes:
a judging section which judges whether or not the device is driven by the battery when the execution of the shutdown processing of the operating system is required; and
a permitting section which permits the execution of the shutdown processing of the operating system when it is judged that the device is driven by the battery.

9. A shutdown method of an operating system of an information processing device having an executing section which executes an operating system; a body having a housing with a peripheral wall; a connection hole which is made in the peripheral wall of the housing and into which a hook portion of a lock unit is insertable, the lock unit having the hook portion which is rotatable between a locked position and an unlocked position; and a detecting section which detects whether or not the hook portion of the lock unit is inserted into the connection hole, the method comprising:
judging whether or not the hook portion is inserted into the connection hole when execution of shutdown processing of the operating system is required; and
prohibiting the execution of the shutdown processing of the operating system until the hook portion is inserted into the connection hole when it is judged that the hook portion is not inserted into the connection hole.

10. The shutdown method of the operating system according to claim 9, wherein the information processing device further includes a speaker,
the method further comprising:
emitting a predetermined sound from the speaker when it is judged that the hook portion is not inserted into the connection hole.

11. The shutdown method of the operating system according to claim 9, wherein the information processing device further includes a display panel,
the method further comprising:
displaying a predetermined message in the display panel when it is judged that the hook portion is not inserted into the connection hole.

12. The shutdown method of the operating system according to claim 9, wherein the information processing device is drivable by a battery,
the method further comprising:
judging whether or not the device is driven by the battery when the execution of the shutdown processing of the operating system is required; and
permitting the execution of the shutdown processing of the operating system when it is judged that the device is driven by the battery.
